(19) United States
(12) Patent Application Publication
(10) Pub. No.: US 2002/0142768 A1
(43) Pub. Date: Oct. 3, 2002

(54) Position display system using wireless mobile terminals

(76) Inventors: Kunio Murata, Koyoen Nishinomiya-city (JP); Osami Kitagawa, Zushi-shi (JP); Shigeki Moriyama, Abiko-shi (JP); Yoshihiko Nagata, Yokosuka-shi (JP); Ichiro Hayashi, Tokyo (JP); Yukitaka Hihara, Tokyo (JP)

Correspondence Address: CISLO & THOMAS, LLP, 233 WILSHIRE BLVD, SUITE 900, SANTA MONICA, CA, 90401-1211, US

(21) Appl. No.: 09/902,308

(22) Filed: Jul. 9, 2001

(30) Foreign Application Priority Data
Mar. 27, 2001 (JP) 2001-090764

(51) Int. Cl. H04Q 7/20

(52) U.S. Cl. 455/426; 455/435

(57) ABSTRACT

A position display system using wireless mobile terminals for determining the route to be taken by a traveler is provided. The system utilizes information provided by the traveler such as the destination path, and other information for determining a fortune-wise optimal route, or for determining an azimuth or the lucky azimuth of destination.

### CROSS-REFERENCES TO RELATED APPLICATIONS

This patent application claims priority from Japanese Patent Application No. 2001-90764 filed on Mar. 27, 2001.

### BACKGROUND OF THE INVENTION

1. Field of the Invention

This invention relates to a position display system using wireless mobile terminals and, more particularly to, such a position display system that provides a specific guide by displaying a fortune-wise optimal route.

2. Description of the Related Art

There has been a remarkable progress in the technologies of a portable telephone, PHS, or other wireless mobile terminals leading to a drastic increase in their use, which is now higher than that of fixed or subscriber type telephones. The wireless mobile terminals have been diffused so rapidly, and a variety of forms of information providing services utilizing those terminals are being suggested and put to practical use.

### SUMMARY OF THE INVENTION

It is an object of the present invention to provide a position display system using wireless mobile terminals for determining the route to be taken by a traveler. The travel rout is determined based on information which includes the current position of the traveler, the desired destination, and other information for determining a fortune wise path, and an azimuth or a lucky azimuth of a destination.

### OBJECTS OF THE INVENTION

It is an object of the present invention to provide a position display system using wireless mobile terminals for determining the route to be taken by a traveler.

It is a further object of the present invention to determine a fortune wise optimal path to be taken by the traveler, based on religious or otherwise new age belief systems.

These and other objects and advantages of the present invention will be apparent from a review of the following specification and accompanying drawings.

### BRIEF DESCRIPTION OF THE DRAWINGS

FIG. 1 is a system configuration diagram illustrating a first embodiment of a position display system using wireless mobile terminals according to the present invention;

FIG. 2 is a flowchart illustrating functions of a position display system of FIG. 1;

FIG. 3 is a system configuration diagram illustrating a second embodiment of a position display system using wireless mobile terminals according to the present invention;

FIG. 4 is a system configuration diagram illustrating a third embodiment of a position display system using wireless mobile terminals according to the present invention;

FIG. 5 is a flowchart illustrating functions of a position display system according to the third embodiment;

FIG. 6 is a system configuration diagram illustrating a fourth embodiment of a position display system using wireless mobile terminals according to the present invention;

FIG. 7 is a system configuration diagram illustrating a fifth embodiment of a position display system using wireless mobile terminals according to the present invention;

FIG. 8 is a flowchart illustrating functions of a position display system using wireless mobile terminals of FIG. 7; and

FIG. 9 is a system configuration diagram illustrating a sixth embodiment of a position display system using wireless mobile terminals according to the present invention.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

A “wireless mobile terminal” referred to in this specification may include a variety of wireless mobile terminals including a portable telephone, PHS, and other mobile telephone carried by a person, a mobile computer having a portable telephone function, a palm device capable of communication when connected with a portable telephone, a car navigation terminal mounted to a car, and the like. Although the following will exemplify a portable terminal carried by a person, the present invention is applicable to any other wireless mobile terminals.

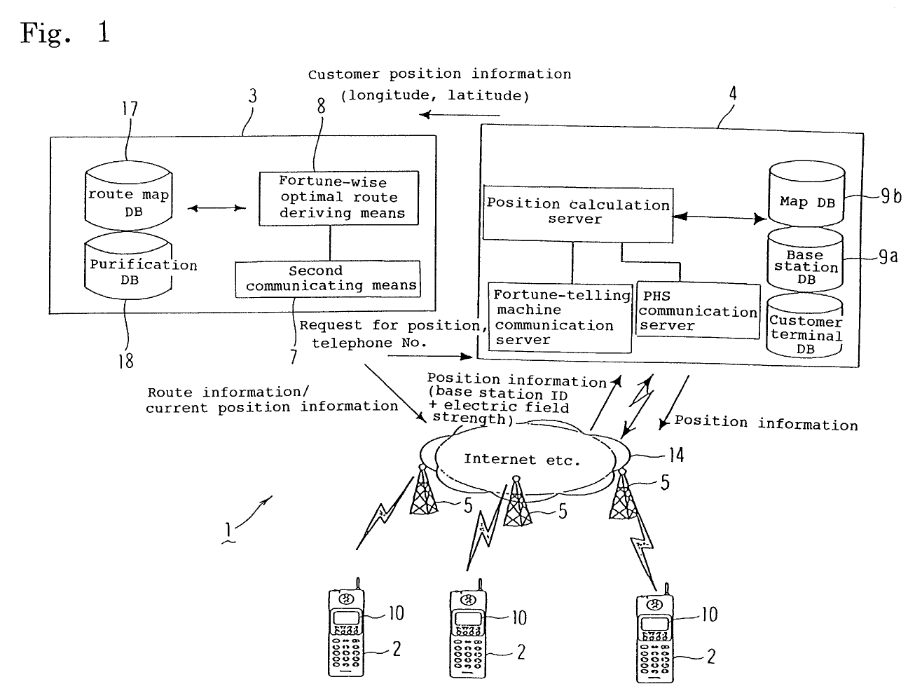

FIG. 1 is a system configuration diagram illustrating a first embodiment of a position display system using wireless mobile terminals in accordance with the present invention.

A position display system (1) related to the first embodiment includes a portable terminal (2), a fortune-telling machine (3), and a position information managing station (4), configured such that the fortune-telling machine (3) provides an azimuth science-wise lucky and fortune-wise optimal route which is displayed on the portable terminal (2).

The portable terminal (2) has a first communication element (not shown) for receiving a radio wave from a plurality of peripheral base stations (5) and transmitting via the base stations (5) to the position information managing station (4) the terminal position information of a plurality of data pairs each of which pairs consists of a base station ID and an electric field strength received from the base stations (5). Also transmitted to the position information managing station (4) is information (e.g., geographic name) related to a mobile destination of the terminal user.

Although the portable terminal (2) is described as a wireless mobile type of Personal Handy-phone Systems (PHSs), this should not be construed as limiting.

The mobile destination of the terminal user may be, for example, a pilgrimage at 88 temples in Shikoku.

The position information managing station (4) references databases (9a) and (9b) having base station ID information and geographical position information respectively to thereby detect the current position of the portable terminal (2) based on a base station ID and a received electric field strength transmitted from the portable terminal (2) and transmit the detection result, that is, information of the current position of the terminal user to the portable terminal (2) and the fortune-telling machine (3).

The fortune-telling machine (3) has a route deriving element (8) for deriving an azimuth science-wise lucky and fortune-wise optimal route as a route for the terminal user to take when going from the current position of the portable terminal (2) to his destination, based on the position information of the portable terminal (2) and the position information of the portable terminal user, received from the position information managing station (4). Additionally, the fortune-telling machine (3) has a second communication element (7) for transmitting information of the derived route to the portable terminal (2), The machine (3) may be connected to a communication network such as the Internet or a mobile communication network (e.g., PHS network) (14) and the position information managing station (4).

The fortune-telling machine (3) further has a route map database (17) and a purification database (18).

The fortune-telling machine (3) is controlled by the CPU and provided with an external memory such as a hard disk or CD-ROM.

The fortune-telling machine (3) also stores the birthday of the terminal users and other such information, and is capable of fortune telling based on the information.

The portable terminal (2) shows on display (10) both the selected route and the current position of the portable terminal (2) based on the information received from the fortune-telling machine (3) and the position information managing station (4). The display may comprise characters, graphics, and other suitable indications.

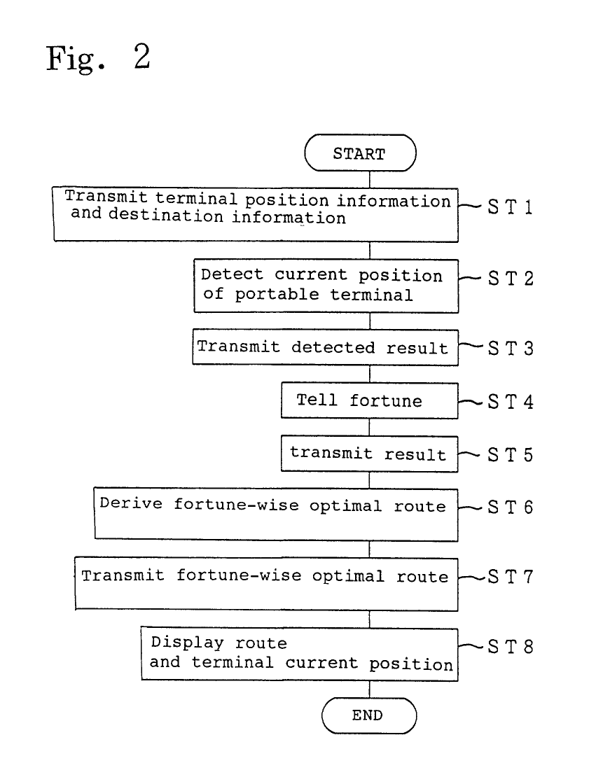

The following will describe one example of the operations of the position display system (1) related to the first embodiment with reference to the flowchart of FIG. 2.

First, information is inputted into the portable terminal (2) through input fields of the terminal (2) which are related to the destination of the terminal user. When he is visiting a location, for example, the 88 temples in Shikoku, he may input the name of the next temples he plans to visit. When the destination and other information is thus inputted, it is transmitted to the position information managing station (4).

The portable terminal (2) receives a radio wave from the plurality of peripheral base stations (5) to then transmit via the base stations (5) to the position information managing station (4) the terminal position information of a plurality of data pairs each of which pairs consists of a base station ID and a received electric field strength (step 1).

The position information managing station (4) references the databases (9a) and, (9b) having the base station ID information and the geographical position information, respectively, detects the current position of the portable terminal (2) based on a base station ID and the electric field strength received from the portable terminal (2) (step 2) and detects a position of the destination, then transmits those detection results to the portable terminal (2) and the fortune-telling machine (3) (step 3).

The fortune-telling machine (3) uses a fortune-telling analysis, not shown, to tell the azimuthally related fortune of the portable terminal user (step 4) and transmits the result to the portable terminal (2) in response to a transmission request received therefrom (step 5). Also, the fortune-telling machine (3) derives an azimuth science-wise lucky and fortune-wise optimal route as a route for the terminal user when going from the current position to his destination based on the position information of the portable terminal (2) received from the position information managing station (4) and the position information of the destination of the portable terminal user (step 6). Information of the fortune-wise optimal route is transmitted to the portable terminal (2) in response to a transmission request received therefrom (step 7).

The portable terminal (2) shows on the display (10) , using characters, graphics or any other suitable indications, the current position of portable terminal (2) and the derived fortune-wise optimal route based on the information received from the fortune-telling machine (3) and the position information managing station (4) (step 8).

The route is not limited in display form and may be shown for example by an arrow indicating a constantly changing azimuth or by the names of intermediate destination places. Such display contents can be indicated on a map to easily indicate the route.

Note here that the portable terminal (2) may display the destination of the terminal user, in which case the destination can be displayed by a place name or a landscape photo, a photo or picture of a landmark building, and the like.

Also, hotels, restaurants, and the like along the route may be displayed in a banner advertisement. Such a system will allow these establishments to advertise, and may include discount incentives, whereby the user viewing the advertisements, may be entitled to a discount when he visits the particular establishment.

Also, although according to the first embodiment the information of the current position of the portable terminal (2) is transmitted from the position information managing station (4) to the portable terminal (2), it may also be transmitted from the fortune-telling machine (3) to the portable terminal (2).

Additionally, according to the first embodiment, other features may be added. For example, a feature may be provided by which the daily fortune may be told regarding azimuth, love affair, work, and the like, which is transmitted to the portable terminal (2).

Also, if the fortune of the day is bad, a shrine maiden or priest may be displayed on the portable terminal (2) in animation to thereby improve one's fortune by purification, according to some beliefs.

Also, a portrait of a god or Buddha worshipped by the terminal user may be transmitted from the fortune-telling machine (3) to the portable terminal (2) and stored therein as an amulet.

Additionally, as for an encounter with a person of interest or a lover, such a route starting from a current position can be indicated that is predicted to actualize the encounter.

Although the above-mentioned first embodiment utilizes a received electric field strength and a base station ID to thereby detect a current position of a portable terminal, a Global Positioning System (GPS) for receiving a radio wave from a GPS satellite to thereby detect the position of the portable terminal may be utilized in stead, for detecting the current position of the portable terminal in accordance with the second embodiment.

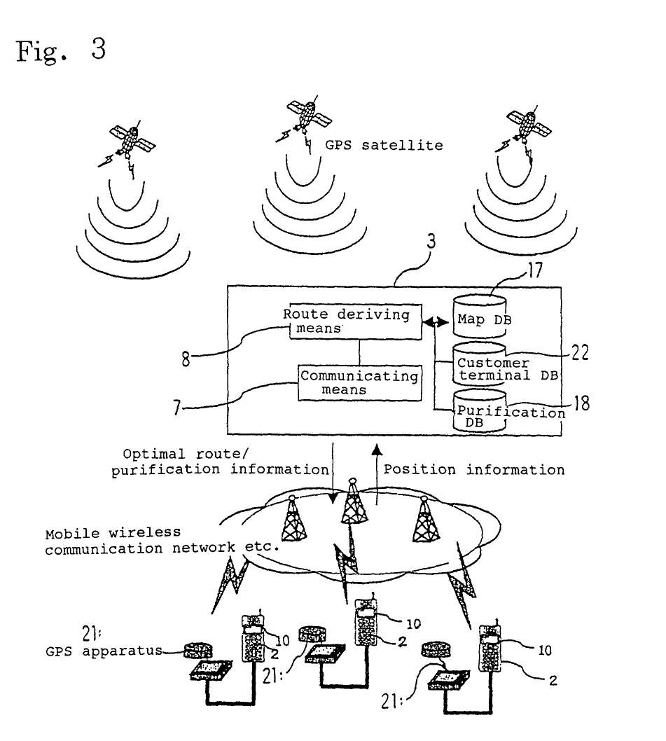

As shown in FIG. 3 such position display system (1) using portable terminals includes the portable terminal (2) incorporating a GPS apparatus (21), and the fortune-telling machine (3).

As such, the portable terminal (2) has a built in or externally connected GPS apparatus (21) having GPS reception including position detecting element for detecting the current position of the portable terminal based on terminal position information obtained from the reception, and a communication element for transmitting information of the detected current position. Also, the portable terminal (2) is adapted for being capable of inputting a mobile destination of a portable terminal user and transmitting the relevant information to the fortune-telling machine (3).

The fortune-telling machine (3) is provided with the route deriving element (8) for deriving an azimuth science-wise lucky and fortune-wise optimal route, as the best route for the portable terminal user when going to his destination based on information of the current position of the portable terminal (2) transmitted from the GPS apparatus (21) and information related to the destination of the portable terminal user transmitted from the portable terminal (2) and the communication element (7) for transmitting information of thus derived route to the portable terminal (2).

This fortune-telling machine (3) also has a route map database (17), a customer terminal information database (22), and the purification information database (18). 20 The portable terminal (2) shows on display (10) the fortune-wise optimal route and the current position of the portable terminal (2) based on the information obtained from the fortune-telling machine (3) and the GPS apparatus (21). The display may include characters, graphics, or other suitable depiction of the route.

In this embodiment, the GPS apparatus (21) transmits to the fortune-telling machine (3) the current position information of the portable terminal (2). The fortune-telling machine (3) can not only receive from the portable terminal (2) the information related to a destination place, but also detect a position of the destination based on that information. The fortune-telling machine (3) derives a fortune-wise optimal route based on such position information and transmits the derived result to the portable terminal (2).

This second embodiment eliminates the need of the position information managing station (4).

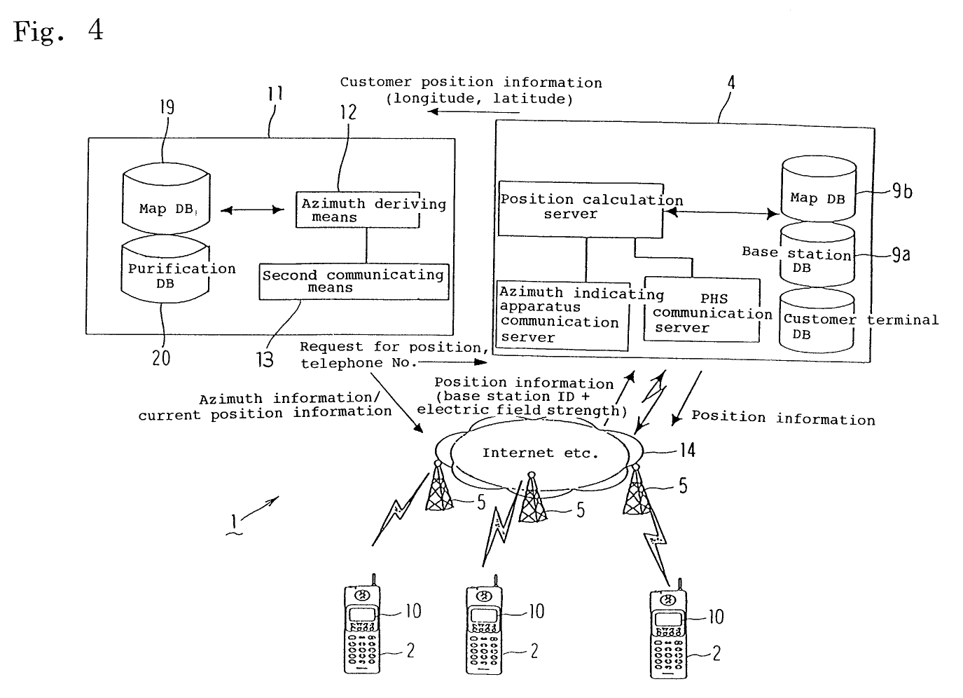

The following will describe a position display system using wireless mobile terminals related to a third embodiment of the invention with reference to FIG. 4.

The position display system (1) related to the third embodiment has the portable terminal (2), an azimuth indicating apparatus (11), and the position information managing station (4).

The position display system (1) related to the third embodiment has the same basic concept as that related to the first embodiment except that the azimuth indicating apparatus (11) is provided in place of the fortune-telling apparatus (3).

According to the third embodiment, when a terminal user wishes to travel or prays toward a distance place, the azimuth is displayed on his portable terminal (2).

The azimuth indicating apparatus (11) is provided with the azimuth deriving element (12) for deriving an azimuth of a destination of a portable terminal user based on position information of the portable terminal (2) received from the position information managing station (4) and position information of the destination of the user of the portable terminal (2). Also the azimuth indicating apparatus (11) has a second communication element (13) for transmitting the azimuth to the portable terminal (2) in response to a transmission request from the portable terminal (2), in such an embodiment the apparatus (11) is connected to a communication network (14) such as the internet or any other mobile communication network (e.g., PHS network) and the position information managing station (4).

The azimuth indicating apparatus (11) is provided with a map database (19) and a purification/sutra information database (20).

The azimuth indicating apparatus (11) is controlled by the CPU and provided with an external memory such as a hard disk or CD-ROM.

The portable terminal (2) shows on the display (10) as a character or a graphic and/or azimuth of the destination of the portable terminal user and a current position of the portable terminal (2) based on information received from the azimuth indicating apparatus (11) and the position information managing station (4).

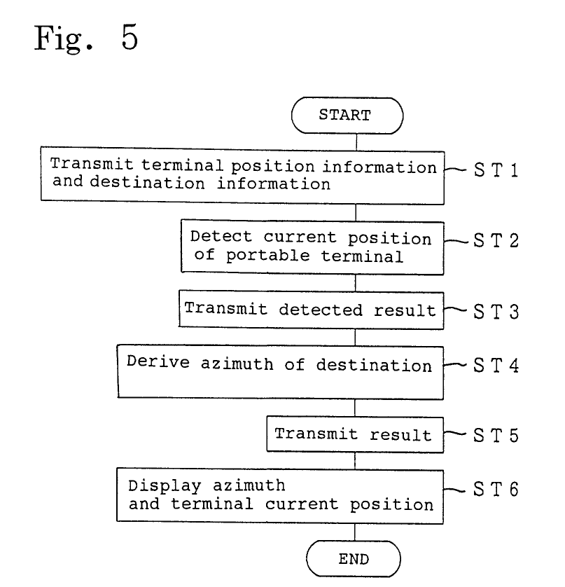

The following will describe the functions of the position display system (1) related to the third embodiment with reference to the flowchart of FIG. 5.

First the destination of the terminal user is input to the portable terminal (2) through its input portion. According to the third embodiment, the destination of the terminal user can be either a position at which the terminal user is to arrive as in the case of the first embodiment, or a position other than that arrival position. The following will exemplify the latter case.

If the terminal user is an Islamite, he inputs as information related to his destination, a name of an Islamic church, (i.e. a mosque), or a name of a place where the mosque is located. After the inputting of the destination, the portable terminal (2) transmits that destination information to the position information managing station (4).

The portable terminal (2), which receives a radio wave from a plurality of peripheral base stations (5), transmits via the base stations (5) to the position information managing station (4) the terminal position information of a plurality of data pairs each of which pairs consists of an ID of a base station and an electric field strength received from this base station (5) (step 1).

The position information managing station (4) references the databases (9a) and (9b) having base station ID information and geographical position information respectively detects a current position of the portable terminal (2) based on a base station ID and a received electric field strength transmitted from the portable terminal (2) (step 2) and also detects a position of the destination and transmits those detection results to the portable terminal (2) and the azimuth indicating apparatus (11) (step 3).

The azimuth indicating apparatus (11) derives an azimuth of the destination of the portable terminal user based on position information of the portable terminal (2) received from the position information managing station (4) and position information of the destination of the user of the portable terminal (2) (step 4) then transmits that azimuth to the portable terminal (2) in response to a transmission request from the portable terminal (2) (step 5).

The portable terminal (2) shows on the display the azimuth of the destination of the portable terminal user and the current position of the portable terminal (2) based on the information received from the azimuth indicating apparatus (11) and the position information managing station (4) (step 6), in character, graphic, or other suitable form

The azimuth is not limited in display form and may be displayed by an arrow or a building etc. which serves as a landmark around the current position. Such features can be displayed on a map to thereby further easily indicate the azimuth.

Note here that although in this third embodiment the current position information of the portable terminal (2) is transmitted from the position information managing station (4) to the portable terminal (2), it may also be transmitted from the azimuth indicating apparatus (11) to the portable terminal (2).

Although the third embodiment utilizes a received electric field strength and a base station ID to detect a current position of the portable terminal, a Global Positioning System (GPS) for detecting the portable terminal position based on a radio wave received from a GPS satellite may be utilized in stead, to thereby detect the current position of the portable terminal according to the fourth embodiment.

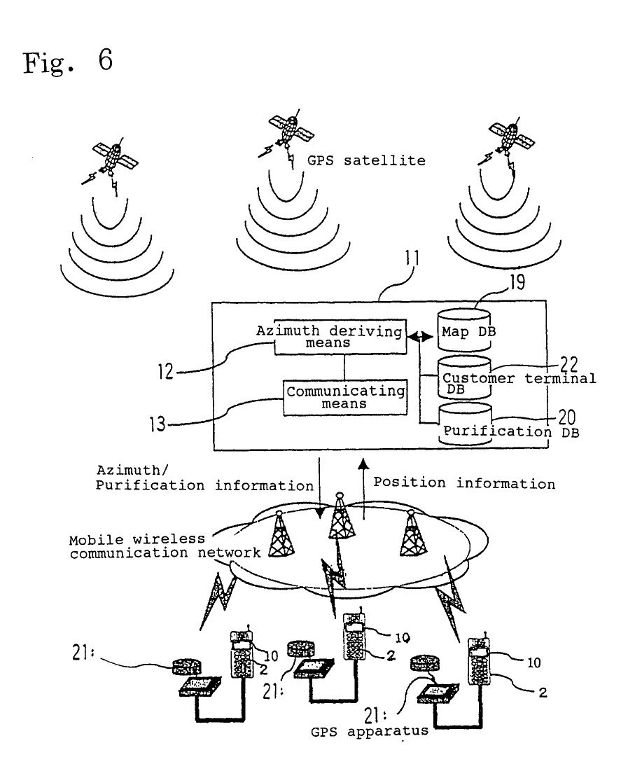

In this case, the position display system (1) using portable terminals comprises the portable terminal (2) including the GPS apparatus (21), and the azimuth indicating apparatus (11), as shown in FIG. 6

That is, the portable terminal (2) has as built in or as externally connected the GPS apparatus (21) provided with a GPS reception element, a position detecting element for detecting a current position of the portable terminal based on terminal position information obtained from the reception element, and a communication element for transmitting information of the detected current position. The portable terminal (2) is also capable of receiving inputted information by the user (e.g., place name and the like) related to his destination, and transmitting that information to the azimuth indicating apparatus (11).

The azimuth indicating apparatus (11) is provided with the azimuth deriving element (12) for deriving an azimuth of a destination of the portable terminal user based on the current position information of the portable terminal (2) transmitted from the GPS apparatus (21) and the information related to the destination of the portable terminal user transmitted from the portable terminal (2) and the communication element (13) for transmitting information of the derived azimuth to the portable terminal (2).

This azimuth indicating apparatus (11) is further provided with the map database (19), the customer terminal information database (22), and the purification/sutra information database (20).

The portable terminal (2) shows on the display (10) the azimuth of the destination of the portable terminal user and the current position of the portable terminal (2) based on the information obtained from the azimuth indicating apparatus (11) and the GPS apparatus (21), in the form of characters, graphic, or other suitable forms.

In this embodiment, the GPS apparatus (21) transmits to the azimuth indicating apparatus (11) the current position information of the portable terminal (2). The azimuth indicating apparatus (11) can receive from the portable terminal (2) the information related to the destination of the terminal user to thereby detect a position of that destination based on that information. The azimuth indicating apparatus (11) derives an azimuth of the destination of the portable terminal user based on such information and then transmits the result to the portable terminal (2).

This fourth embodiment eliminates the need of the position information managing station (4).

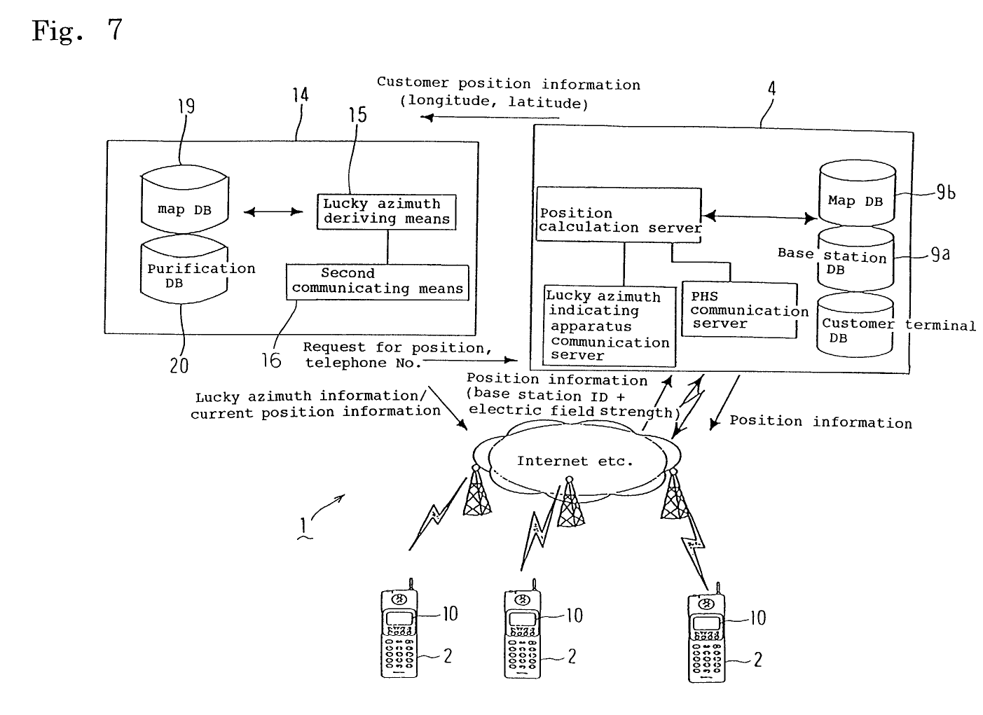

The following will describe the position display system using wireless mobile terminals related to a fifth embodiment of the invention with reference to FIG. 7.

The position display system (1) related to the fifth embodiment has the portable terminal (2), a position information managing station (4), and a lucky azimuth indicating apparatus (14).

The position display system (1) related to the fifth embodiment has the same basic features as that of the first embodiment except that the lucky azimuth indicating apparatus (14) is provided instead of the fortune-telling machine (3).

According to the fifth embodiment, when a place, for example, a building built according to the Feng shui science and the like is to be selected or a lucky azimuth of the day for the activities of that day is to be known, the lucky azimuth can be displayed on the portable terminal (2).

The lucky azimuth indicating apparatus (14) is provided with a lucky azimuth deriving element(15) for deriving an azimuth which is determined to be lucky according to Feng shui science, or other such philosophy, on a position of the portable terminal (2) based on position information of the portable terminal (2) received from the position information managing station (4) and the second communication element (16) for transmitting that lucky azimuth to the portable terminal (2). In this embodiment the apparatus is connected to a public telephone network including a mobile communication network (PHS network in the illustrated example) and the position information managing station (4).

This lucky azimuth indicating apparatus (14) is further provided with a map database (19) and a purification/sutra database (20).

The lucky azimuth indicating apparatus (14) is controlled by the CPU and provided with an external memory such as a hard disk or a CD-ROM.

The lucky azimuth indicating apparatus (14) also stores the birthday of the terminal user and can derive a predicted lucky azimuth using this information.

The portable terminal (2) shows on the display (10) the current position of the portable terminal (2) and an azimuth which is determined to be lucky from the viewpoint of that current position based on the information received from the lucky azimuth indicating apparatus (14) and the position information managing station (4). The display may appear as a character, graphic, or other suitable form.

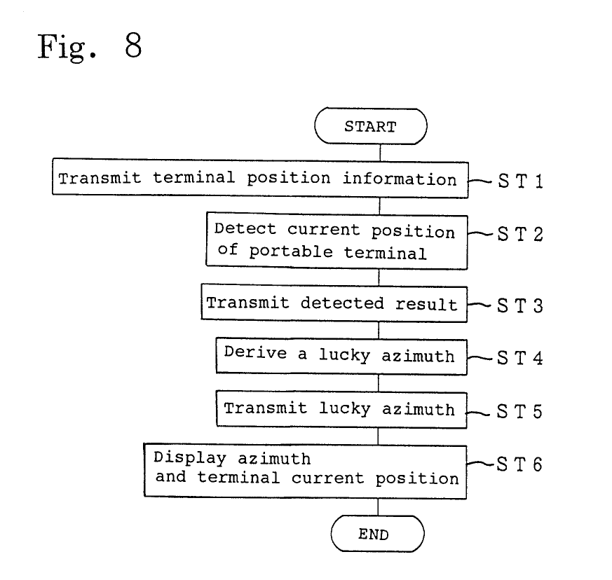

The following will describe the operations of the position display system (1) related to the fifth embodiment with reference to a flowchart of FIG. 8. Here, such a function is exemplified that would select a place where a building, build according to the Feng shui science, is located.

First, the portable terminal (2) is positioned at a place such as a river, which provides a Feng shui point. The portable terminal (2), which receives a radio wave from a plurality of peripheral base stations (5), transmits via the base stations (5) to the position information managing station (4) the position information of a plurality of data pairs each of which pairs consists of an ID of a base station and a received electric field strength from the base station (5) (step 1).

The position information managing station (4) references the databases (9a) and, (9b) having base station ID information and geographical position information respectively, detects a current position of the portable terminal (2) based on the base station ID and the received electric field strength transmitted from the portable terminal (2) (step 2) and then transmits the detection result to the portable terminal (2) and the lucky azimuth indicating apparatus (14) (step 3).

The lucky azimuth indicating apparatus (14) derives as an azimuth for the building an azimuth which is determined to be lucky according to the position of the portable terminal (2) based on the position information of the portable terminal (2) received from the position information managing station (4) (step 4), and then transmits that lucky azimuth to the portable terminal (2) (step 5).

The portable terminal (2) shows on the display (10), the azimuth which was determined to be lucky according to the current position of the portable terminal (2) based on the information received from the lucky azimuth indicating apparatus (14) and the position information managing station (4) (step 6). The azimuth may be displayed in the form of a character, graphic, or other suitable form.

The azimuth is not limited in display form and may be shown by an arrow or a building and the like which provides a landmark around the current position. Those contents can be displayed on a map to thereby easily indicate the azimuth.

Although the system according to the fifth embodiment transmits the current position information of the portable terminal (2) from the position information managing station (4) to the portable terminal (2), the information may also be transmitted from the lucky azimuth indicating apparatus (14) to the portable terminal (2).

Also, although the fifth embodiment utilizes the received electric field strength and the base station ID to thereby detect the current position of the portable terminal, a Global Positioning System (GPS) for detecting the position of the portable terminal based on a radio wave from a GPS satellite may be utilized to detect the current position of the portable terminal, according to the sixth embodiment described herein.

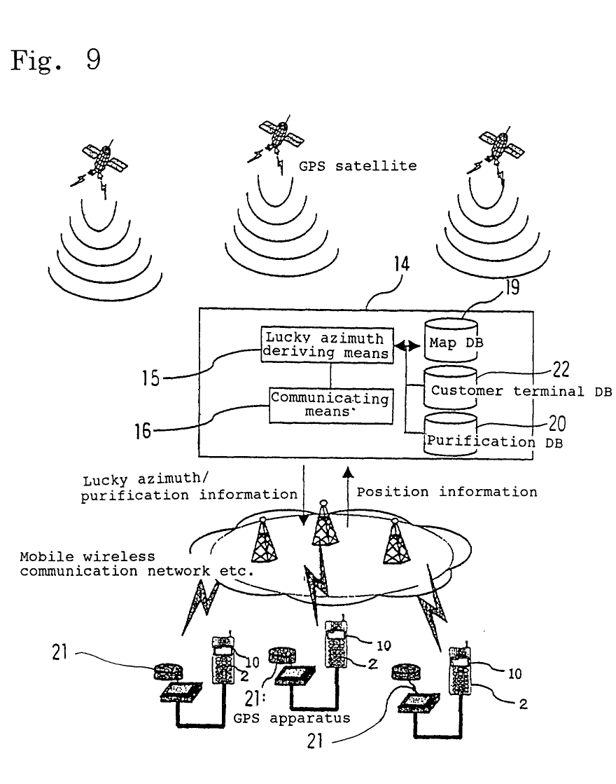

In this case, the position display system (1) using portable terminals has, as shown in FIG. 9, the portable terminal (2) including the GPS apparatus (21) and the lucky azimuth indicating apparatus (14).

The GPS apparatus (21) can be either built in, or externally connected to the portable terminal (2), and has a GPS reception element including a position detecting element for detecting the current position of the portable terminal, and a communication element for transmitting the information of the detected current position.

The lucky azimuth indicating apparatus (14) is provided with the lucky azimuth deriving element (15) for deriving an azimuth which is decided to be lucky according to azimuth science such as the Feng shui science, on the position of the portable terminal (2) based on the current position information of the portable terminal (2) transmitted from the GPS apparatus (21) and the communication element (16) for transmitting to the portable terminal (2) the information of derived lucky azimuth.

The azimuth indicating apparatus (11) also includes the map database (19), the customer terminal information database (22), and the purification information database (20).

According to this embodiment, the GPS apparatus (21) transmits to the lucky azimuth indicating apparatus (14) the current position information of the portable terminal (2). The lucky azimuth indicating apparatus (14) derives a lucky azimuth based on that position information and then transmits the result to the portable terminal (2).

According to the first and second aspects of the invention, the wireless mobile terminal can display a derived fortune-wise optimal route and a current position of the wireless portable terminal to thereby give specific guides for the terminal user when he is moving. The information can be displayed in the form of a character or a graphic, or other suitable form.

According to the third and fourth embodiments of the invention, the wireless mobile terminal can show display, (i.e. in character or graphic form) an azimuth of the destination of the portable terminal user and the current position of the wireless mobile terminal to thereby give specific guides to the terminal user. Such azimuth may be helpful when the user wishes to direct his prayers toward a distance object.

According to the fifth and sixth embodiments of the invention, the wireless mobile terminal can display (i.e. in character or graphic form) an azimuth which is determined to be lucky from the viewpoint of the position of the wireless mobile terminal and a current position of the wireless mobile terminal to thereby give specific activity guides to the user who wishes to select a place where a building is to be build or to know a lucky azimuth of the day according to his act.

What is claimed is:

1. A position display system comprising:
a wireless mobile terminal;
a fortune telling machine for providing a fortune wise optimal route for directing a user of said wireless terminal.

2. The position display system of claim 1, wherein said user is directed to a desired destination.

3. The position display system of claim 1, wherein said fortune telling machine is provided with a route deriving element for deriving an azimuth science-wise lucky and fortune-wise optimal route.

4. The position display system of claim 1, wherein said fortune wise optimal rout and the current position of said terminal is shown on the terminal display using characters, graphics, or a combination thereof.

5. The position display system of claim 1, wherein said fortune telling machine is external to said terminal, and has a communication element for receiving and transmitting information to said terminal.

6. The position display system of claim 1, wherein said optimal route is determined based on the terminal's current position and the desired destination.

7. The position display system of claim 6, further including a position information managing station, external to said terminal, for determining and transmitting said current position to said fortune telling machine.

8. The position display system of claim 7, wherein said desired destination is transmitted from said terminal to said position information managing station to said fortune telling machine.

9. The position display system of claim 7, further including at least one peripheral base station for transmitting said current position information to said terminal, wherein said current position information and said destination information are transmitted from the terminal to the information managing station.

10. The position display system of claim 1 further comprising:
at least one peripheral base station; and
a position information managing station; whereby
said wireless mobile terminal is provided with a first communication element for receiving a radio wave from said peripheral base station to then transmit via said base stations to a position information managing station the terminal position information of a plurality of data pairs each of which consists of a base station ID and a received electric field strength, and also transmit to said position information managing station information related to a destination of said wireless mobile terminal user;
said position information managing station being capable of referencing databases having base station ID information and geographical position information respectively, to thereby detect a current position of said wireless mobile terminal based on said base station ID and a received electric field strength transmitted from said wireless mobile terminal, and to transmit the detection result to a fortune-telling machine;
said fortune-telling machine provided with a route deriving element for deriving an azimuth science-wise lucky and fortune-wise optimal route as a route for said wireless mobile terminal user based on the position and destination information received from said position information managing station, and a second communication element for transmitting information of said route thus derived to said wireless mobile terminal,
wherein said wireless mobile terminal displays said fortune-wise optimal route and said current position of said wireless mobile terminal based on information obtained from said fortune-telling machine and said position information managing station.

11. The position display system of claim 1 further comprising a GPS unit for detecting current position information of said terminal, and transmit said current position information to said fortune telling machine, whereby said fortune-wise optimal route is determined based on said current position information.

12. The position display system of claim 11, wherein said GPS unit transmits destination information to said fortune-telling machine wherein said fortune-wise optimal route is determined based on the destination and current position information.

13. The position display system of claim 11, wherein said GPS unit is externally connected to said terminal.

14. The position display system of claim 11, wherein said GPS unit includes:
a reception element;
a position detecting element for detecting a current position of said wireless mobile terminal based on terminal position information obtained from said reception element; and
a communication element for transmitting information of a detected current position and for transmitting information related to a destination of a wireless mobile terminal user; and wherein
said fortune-telling machine is provided with a route deriving element for deriving said fortune-wise optimal route as a route for said wireless mobile terminal user when going to a destination based on information of said current position and destination, and a communication element for transmitting information regarding said derived route to said wireless mobile terminal user,
wherein said route is displayed on said wireless mobile terminal in the form of characters, graphics, or a combination thereof.

15. A position display system comprising:
a wireless mobile terminal;
an azimuth indicating apparatus provided with an azimuth-deriving element for deriving an azimuth of a destination of the wireless mobile terminal user for directing said user.

16. The position display system of claim 15, wherein said azimuth of said destination is shown on the terminal display using characters, graphics, or a combination thereof.

17. The position display system of claim 15, wherein said azimuth indicating apparatus is external to said terminal, and has a communication element for receiving and transmitting information to said terminal.

18. The position display system of claim 15, wherein said azimuth of said destination is determined based on the terminal's current position and the desired destination.

19. The position display system of claim 15 further comprising:
at least one peripheral base station; and
a position information managing station; whereby said wireless mobile terminal is provided with a first communication element for receiving a radio wave from said peripheral base station to then transmit via said base stations to a position information managing station the terminal position information of a plurality of data pairs each of which consists of a base station ID and a received electric field strength, and also transmit to said position information managing station information related to a destination of said wireless mobile terminal user;
said position information managing station being capable of referencing databases having base station ID information and geographical position information respectively, to thereby detect a current position of said wireless mobile terminal based on said base station ID and a received electric field strength transmitted from said wireless mobile terminal, and to transmit the detection result to a fortune-telling machine;
said azimuth indicating apparatus provided with an azimuth deriving element for deriving an azimuth of a destination of said wireless mobile terminal based on the position and destination information received from said position information managing station, and a second communication element for transmitting information of said azimuth thus derived to said wireless mobile terminal,
wherein said wireless mobile terminal displays said azimuth of said destination and said current position of said wireless mobile terminal based on information obtained from said azimuth indicating apparatus and said position information managing station.

20. The position display system of claim 15 further comprising a GPS unit for detecting current position information of said terminal, and transmit said current position information to said azimuth indicating apparatus, whereby said azimuth of said destination is determined based on said current position information.

21. The position display system of claim 20, wherein said GPS unit transmits destination information to said azimuth indicating apparatus wherein said azimuth of said destination is determined based on the destination and current position information.

22. The position display system of claim 20, wherein said GPS unit is externally connected to said terminal.

23. The position display system of claim 20, wherein said GPS unit includes:
a reception element;
a position detecting element for detecting a current position of said wireless mobile terminal based on terminal position information obtained from said reception element; and
a communication element for transmitting information of a detected current position and for transmitting information related to a destination of a wireless mobile terminal user; and wherein
said azimuth indicating apparatus is provided with an azimuth deriving element for deriving said azimuth of said destination for said wireless mobile terminal user when going to a destination based on information of said current position and destination, and a communication element for transmitting information regarding said derived azimuth of said destination to said wireless mobile terminal user,
wherein said azimuth of said destination is displayed on said wireless mobile terminal in the form of characters, graphics, azimuths or a combination thereof.

24. A position display system comprising:
a wireless mobile terminal;
a lucky azimuth indicating apparatus provided with a lucky azimuth deriving element for deriving a lucky azimuth of a destination of the wireless mobile terminal user for directing said user.

25. The position display system of claim 24, wherein said lucky azimuth of said destination is shown on the terminal display using characters, graphics, or a combination thereof.

26. The position display system of claim 24, wherein said lucky azimuth indicating apparatus is external to said terminal, and has a communication element for receiving and transmitting information to said terminal.

27. The position display system of claim 24, wherein said lucky azimuth of said destination is determined based on the terminal's current position and the desired destination.

28. The position display system of claim 24, wherein said lucky azimuth of said destination is determined to be lucky based on azimuth science, Feng shui science, or a combination thereof.

29. The position display system of claim 24 further comprising:
at least one peripheral base station; and
a position information managing station; whereby said wireless mobile terminal is provided with a first communication element for receiving a radio wave from said peripheral base station to then transmit via said base stations to a position information managing station the terminal position information of a plurality of data pairs each of which consists of a base station ID and a received electric field strength, and also transmit to said position information managing station information related to a destination of said wireless mobile terminal user;
said position information managing station being capable of referencing databases having base station ID information and geographical position information respectively, to thereby detect a current position of said wireless mobile terminal based on said base station ID and a received electric field strength transmitted from said wireless mobile terminal, and to transmit the detection result to a fortune-telling machine;
said lucky azimuth indicating apparatus provided with an azimuth deriving element using azimuth science, Feng shui science, or a combination thereof, for deriving a lucky azimuth of a destination of said wireless mobile terminal based on the position and destination information received from said position information managing station, and a second communication element for transmitting information of said lucky azimuth thus derived to said wireless mobile terminal,
wherein said wireless mobile terminal displays said lucky azimuth of said destination and said current position of said wireless mobile terminal based on information obtained from said lucky azimuth indicating apparatus and said position information managing station.

30. The position display system of claim 24 further comprising a GPS unit for detecting current position information of said terminal, and transmit said current position information to said lucky azimuth indicating apparatus, whereby said lucky azimuth of said destination is determined based on said current position information.

31. The position display system of claim 30, wherein said GPS unit transmits destination information to said lucky azimuth indicating apparatus wherein said lucky azimuth of said destination is determined based on the destination and current position information.

32. The position display system of claim 30, wherein said GPS unit is externally connected to said terminal.

33. The position display system of claim 30, wherein said GPS unit includes:
a reception element;
a position detecting element for detecting a current position of said wireless mobile terminal based on terminal position information obtained from said reception element; and
a communication element for transmitting information of a detected current position and for transmitting information related to a destination of a wireless mobile terminal user; and wherein
said lucky azimuth indicating apparatus is provided with a lucky azimuth deriving element for deriving said lucky azimuth of said destination for said wireless mobile terminal user when going to a destination based on information of said current position and destination, and a communication element for transmitting information regarding said derived lucky azimuth of said destination to said wireless mobile terminal user,
wherein said lucky azimuth of said destination is displayed on said wireless mobile terminal in the form of characters, graphics, azimuths or a combination thereof.

34. A position display method comprising:
determining a fortune wise optimal route for a wireless mobile terminal user based on a desired destination and current position of the user
transmitting information regarding said route to indicating a fortune wise optimal route to said terminal.

35. A position display method comprising:
determining an azimuth of a destination for a wireless mobile terminal user based on a desired destination and current position of the user
transmitting said information regarding said azimuth of said destination to said terminal.
